(19) United States
(12) Patent Application Publication
(10) Pub. No.: US 2006/0080735 A1
(43) Pub. Date: Apr. 13, 2006

(54) Methods and systems for phishing detection and notification

(75) Inventors: Duane Brinson, Santa Ana, CA (US); Carl Perkins, Santa Ana, CA (US); Philip Dizon, Irvine, CA (US); Karl Buiter, Las Vegas, NV (US); Jesse Pelayo, Irvine, CA (US)

Correspondence Address: STETINA BRUNDA GARRED & BRUCKER, 75 ENTERPRISE, SUITE 250, ALISO VIEJO, CA, 92656, US

(73) Assignee: USA Revco, LLC

(21) Appl. No.: 11/080,127

(22) Filed: Mar. 15, 2005

Related U.S. Application Data
(60) Provisional application No. 60/614,842, filed on Sep. 30, 2004.

(51) Int. Cl. G06F 12/14

(52) U.S. Cl. 726/22

(57) ABSTRACT

Various techniques are provided for detecting phishing attacks and notifying users of such attacks. In one example, a machine-implemented method can be provided for detecting a phishing attack over a computer network. A web page can be accessed and information associated with the web page can be processed. One or more conditions can be set in response to the processing. The conditions can be compared to a set of conditions indicative of a phishing attack. A user can then be informed of a potential phishing attack corresponding to the conditions through the display of an alert window and/or an icon. Such actions can also be performed in response to a user's selection of a link appearing in an email message. Appropriate systems and/or computer readable media incorporating these features can also be provided.

### CROSS-REFERENCE TO RELATED APPLICATIONS

This application relates to and claims the benefit of U.S. Provisional Application No. 60/614,842 filed Sep. 30, 2004 and entitled ANTI-PHISHING ARCHITECTURE, which is incorporated by reference herein.

### STATEMENT RE: FEDERALLY SPONSORED RESEARCH/DEVELOPMENT

Not Applicable

### BACKGROUND OF THE INVENTION

In recent years, the rise of the Internet and the proliferation of networked communication has facilitated online interaction between a large number of persons and entities. As a result, the Internet has become an important tool for the exchange of information, including personal information. For example, many consumers regularly engage in online banking or other online activities. Such activities often require users to provide personal information such as account numbers, passwords, credit card numbers, and other information.

However, the exchange of personal information over the Internet has also resulted in the propagation of a large number of “phishing” schemes that attempt to obtain users' personal information through deceptive electronic communications. Phishing often involves the providing of a sham email message or web page to a user. For example, an email message containing an HTML input form may be provided to a user, seeking to fool the user into submitting personal, financial, and/or password data. Other phishing techniques may involve displaying to the user a sham web page that replicates features of another legitimate web page. The sham page may request personal information from the user, leading the user to believe that the user is providing information to a legitimate entity, when in reality the user is providing the information to a phishing entity.

Such phishing schemes create significant risks to the unwary consumer. Nefarious persons posing as otherwise legitimate entities may use phishing techniques to engage in identify theft, fraud, and generally malicious behavior. Unfortunately, many consumers are left with little or no protection from these techniques. Given the malicious nature of many phishing schemes, a consumer's own acumen may be insufficient to discern between legitimate and illegitimate electronic communications.

### BRIEF SUMMARY OF THE INVENTION

Various aspects of the present invention, roughly described, provide methods and systems for detecting possible phishing attacks and/or notifying a user of such attacks.

In one embodiment, a machine-implemented method can be provided for detecting a phishing attack over a computer network. A web page can be accessed and information associated with the web page can be processed. One or more conditions can be set in response to the processing. The conditions can be compared to a set of conditions indicative of a phishing attack. A user can then be informed of a potential phishing attack corresponding to the conditions. A large number of conditions can be supported by this and other methods contemplated by the present disclosure.

In various embodiments, the method can be performed in response to a user's selection of a link appearing in an email message. In other embodiments, the user can be informed of potential phishing attacks through the displaying of an alert window to the user, the displaying of an icon to the user, and/or other ways.

In other embodiments, the processing step can comprise: parsing a URL associated with the web page, scanning tags of the web page, analyzing non-tagged content of the web page, analyzing input by the user into a form on the web page, analyzing a URL associated with the web page, analyzing an IP address associated with the web page, and/or other steps set more fully set forth in the present disclosure.

In further embodiments, appropriate systems and/or computer readable media incorporating various features set forth in the present disclosure can be provided for detecting phishing attacks over computer networks.

These and other embodiments in accordance with various aspects of the present invention are discussed in further detail below.

### BRIEF DESCRIPTION OF THE DRAWINGS

FIG. 1 illustrates a block diagram of a networked computer system in accordance with an embodiment of the present invention.

FIG. 2 illustrates a block diagram of several software components running on a user computer in accordance with an embodiment of the present invention.

FIG. 3 illustrates a block diagram of a processing module in accordance with an embodiment of the present invention.

FIG. 4 illustrates a block diagram of supporting data files in accordance with an embodiment of the present invention.

FIG. 5 is a flowchart illustrating a process for detecting phishing attacks in accordance with an embodiment of the present invention.

FIG. 6 is a flowchart illustrating a process for detecting a suspect phishing page in accordance with an embodiment of the present invention.

FIG. 7 is a flowchart illustrating a process for detecting a web mail page in accordance with an embodiment of the present invention.

FIG. 8 is a flowchart illustrating a process for detecting a phishing target page in accordance with an embodiment of the present invention.

FIG. 9 is a flowchart illustrating a process for scanning HTML tags in accordance with an embodiment of the present invention.

FIG. 10 is a flowchart illustrating a process for detecting a form and a phishing target domain page in accordance with an embodiment of the present invention.

FIG. 11 illustrates a heuristics table identifying a matrix for determining phishing conditions in accordance with an embodiment of the present invention.

FIG. 12 illustrates a screenshot of an alert window that can be displayed by a user computer in accordance with an embodiment of the present invention.

### DETAILED DESCRIPTION OF THE INVENTION

The present inventors have recognized various characteristics, the presence or absence of which can be indicative of potential phishing attacks. In various embodiments of the present invention, such characteristics can be detected, and a user can be notified of the possible existence of a phishing attack. Several of these characteristics are set forth in the following paragraphs.

Users often access web pages by selecting a hyperlink found in an email message. Although many users have become accustomed to accessing such links, the inclusion of these links in email messages can allow potential phishing parties to direct the user to a particular web page designed for phishing purposes. As such, the opening of such a linked web page can be a characteristic indicative of a possible phishing attack.

The existence of phishing terms (typically financial terms) or the domain name of a financial and/or transaction services company on a web page can also be indicative of a potential phishing attack.

Other phishing attacks may disguise their intended hyperlink by specifying a “safe” domain name in the username portion of a URL (for example, in a “mailto” URL). However, such use can be very uncommon in legitimate communications, and is often not noticed by users. A phishing attack may make the “safe domain” appear very visible, but obscure the @ reference and the actual domain that the hyperlink will link to. For example, the link “www.yahoo.com@clear-search.com” will link to clear-search.com, not yahoo.com. Other phishing attack may obscure hyperlinks with escape characters.

Users often assume that if a web address is displayed on a web page, any underlying hyperlink will go to the same location. However, when these mismatch, it can be another characteristic indicative of a phishing attack.

Another phishing characteristic can occur when a user is directed to a legitimate web page, and then a popup user/password form from another web page is displayed to collect data from the user within a predetermined time period before or after the opening of the legitimate web page.

The use of escape characters in the URL path of an anchor HREF embedded in an email message can also give rise to a phishing characteristic. Although escape characters can be used to numerically represent specific characters, its use is uncommon in most legitimate hyperlinks. Similarly, the use of a 32-bit (1234567890) address in the URL domain name of an anchor HREF embedded in an email message can also give rise to a phishing characteristic. The use of such 32-bit addresses is uncommon.

Legitimate web pages typically employ the HTTPS scheme when confidential/personal information is to be exchanged through web pages, including form content. When form content appears on a web page using a non-HTTPS scheme, this may indicate phishing behavior.

The entry of a valid credit card number by a user into a form window of a web page can also be indicative of a possible phishing attack, especially in combination with other phishing characteristics. Similarly, the existence of an open form on a web page can also be indicative of a possible phishing attack, especially in combination with other phishing characteristics.

A web page having an IP address associated with a particular country from which phishing attacks commonly originate can also be indicative of a potential phishing attack.

The use of a dotted decimal (10.10.10.10) address used as a web page address can also be indicative of a potential phishing attack. Such addresses can be used to obscure the domain of a potential phishing web page.

Phishing attacks may sometimes obscure words that appear readable by the user but are stored differently. For example, the use of escape characters or other easily confused characters (such as using the letter “L” instead of the letter “I”) can also be used to obscure the actual web page address used by a web page associated with phishing. Use of such characters in a web address may indicate a potential phishing attack.

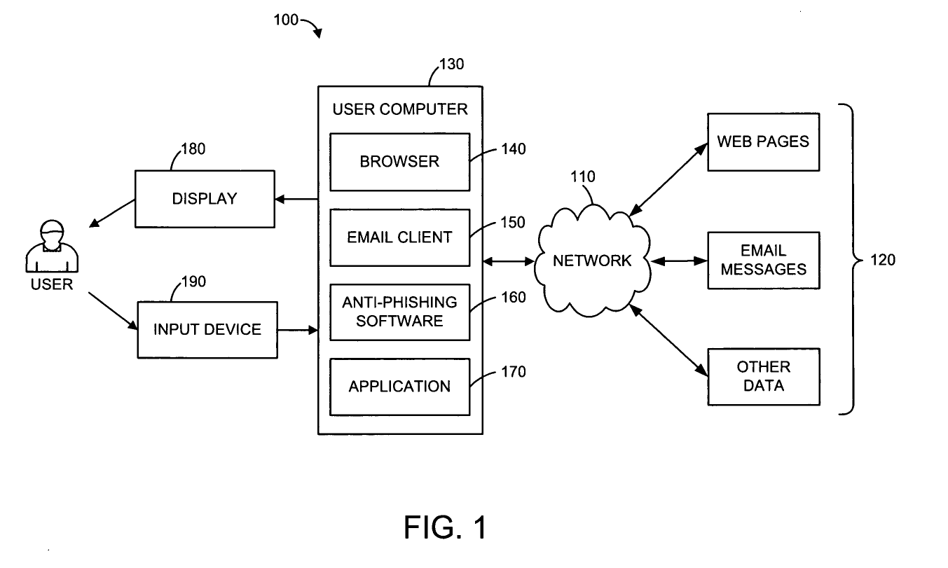

Turning now to the figures of the present disclosure, FIG. 1 illustrates a block diagram of a networked computer system 100 in accordance with an embodiment of the present invention. Through the operation of anti-phishing software 160 running on a user computer 130, a user of the computer 130 can be notified of various potential phishing threats/attacks encountered when accessing information over network 110.

As illustrated, a user computer 130 can be provided in communication with network 110. Network 110 can be any of the various types of networks known in the art to facilitate data transmission, including but not limited to the Internet, a wide area network (WAN), a virtual private network (VPN), a wireless network, and/or others known in the art.

Various data 120 can be accessed by the computer 130 over the network 110. Such data 120 can include, but need not be limited to: web pages, email messages, and/or other data. The data 120 can be associated with particular URLs, email messages, and/or other data association methods known in the art. It will be appreciated that data 120 can be situated anywhere in the world and can be available from any number of servers, other clients, and other data storage methods known in the art.

An input device 190 in communication with computer 130 can receive data input by the user for operating the computer 130. It will be appreciated that the input device 190 can be any appropriate type of input device known in the art, including but not limited to a keyboard, mouse, touchpad, trackball, and/or other appropriate input devices.

System 100 can also provide a display/monitor 180 in communication with computer 130 for displaying output of the system 100, such as data accessed by the computer 130 and/or alerts provided by the system, as further described herein.

A plurality of software can be provided on user computer 130. In particular, a browser 140 can be provided for accessing web pages (i.e. “web surfing”) available over network 110. It will be appreciated that browser 140 can be implemented as an Internet Explorer web browser available from Microsoft Corporation. However, it is contemplated that browser 140 may also be implemented using other web browsers known in the art.

An email client 150 can also be provided on computer 130 for accessing electronic mail messages (i.e. “email messages”) also available over network 110. It will be appreciated that email client 150 can be implemented as an Outlook or Outlook Express email client available from Microsoft Corporation. It is contemplated that email client 150 may also be implemented using a Eudora email client available from Qualcomm Incorporated, or other email clients known in the art.

It will further be appreciated that, where appropriate, browser 140 and email client 150 may be implemented as a single application, such as an application available from America Online, Inc., or other applications known in the art.

One or more other software applications 170 for accessing data 120 over the network 110 can also be provided on computer 130.

Anti-phishing software 160 can also be provided on user computer 130. As further described herein, the anti-phishing software 160 can comprise various components for processing web pages and notifying the user of various potential phishing threats/attacks detected by such processing. In various embodiments, anti-phishing software 160 can be implemented as a plug-in to browser 140 and/or an add-in to email client 150. In addition, anti-phishing software 160 can also be configured to run automatically upon the boot-up of computer 130.

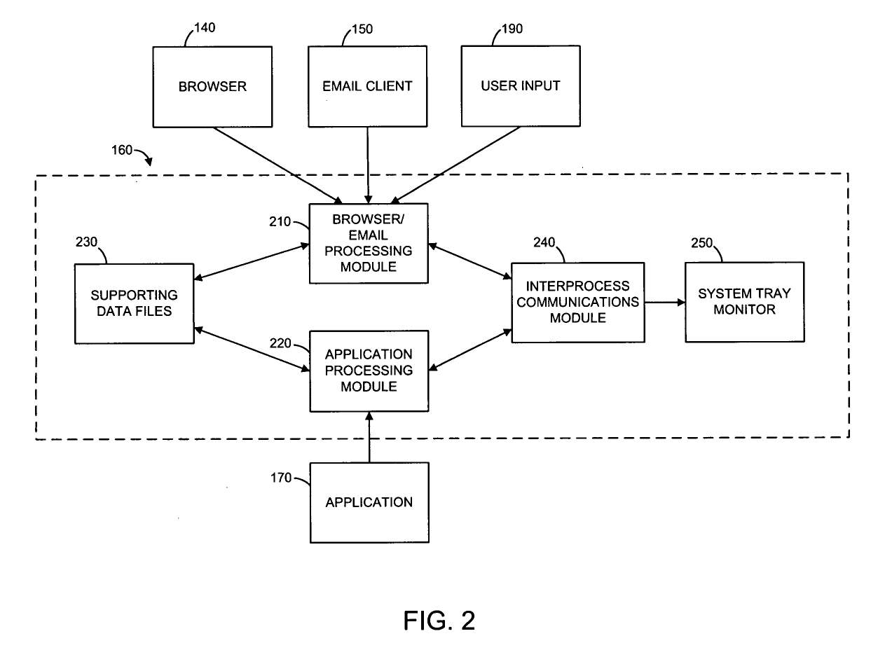

FIG. 2 illustrates a block diagram of several software components running on a user computer 130 in accordance with an embodiment of the present invention.

As previously described, a browser 140, email client 150, and application 170 can be provided on computer 130. In addition, input received from the user through input device 190 can be represented as user input component 190. As illustrated, each of components 140, 150, 170, and 190 can communicate with anti-phishing software 160.

Anti-phishing software 160 can be implemented in accordance with various submodules set forth in FIG. 2. Communication between the anti-phishing software 160 and browser 140 and email client 150 can be facilitated by interfacing with components of a Microsoft Windows compatible operating system, as further described herein.

As illustrated, the anti-phishing software 160 can comprise a browser/email processing module 210, an application processing module 220, supporting data files 230, interprocess communications module 240, and system tray monitor 250.

Processing module 210 can receive communications from browser 140, email client 150, and/or user input 190. Similarly, processing module 220 can receive communications from application 170. Each of the processing modules 210 and 220 can interact with a plurality of supporting data files 230, as further described herein. By processing and comparing information associated with such communications to other data stored in supporting data files 230, the processing modules 210 and 220 can inform communications module 240 of the existence or absence of certain conditions.

Communications module 240 can pass the conditions to system tray monitor 250 which compares the conditions to a heuristic table and/or other data structure in order to determine whether a phishing attack possibly exists. In response, the system tray monitor 250 can notify the user of the possible existence of a phishing attack through the display of an alert window, an icon in the system tray portion of a Windows-based user interface, and/or other information in the display 180 of system 100. In one embodiment, a three-level alert can be employed using yellow, orange, and red colors, with red indicating the most severe alert level.

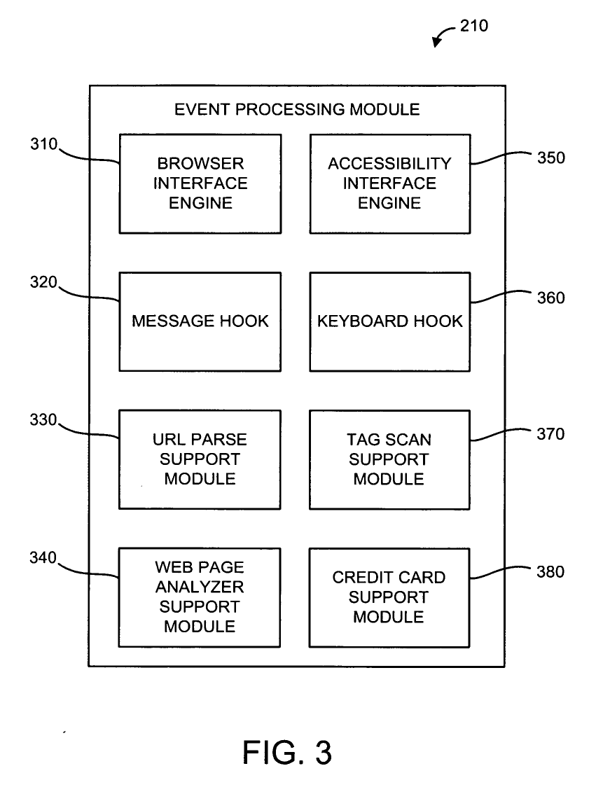

FIG. 3 illustrates a block diagram of a processing module 210 in accordance with an embodiment of the present invention. As illustrated, the processing module 210 comprises a plurality of software components.

A browser interface engine 310 can be provided for supporting communication between browser 140 and the processing module 210. An accessibility interface engine 350 can be provided for supporting communication between browser 140 and/or email client 150 and the processing module 210.

Processing module 210 can further include message hook 320 for scanning the window class of incoming communications for indications of “Internet Explorer_Server”. The message hook 320 can also be implemented to manage the state of credit card detection features and usage of the control key by the user through user input 190. A keyboard hook 360 can also be included for detecting credit card numbers entered by the user through user input 190.

A URL parse support module 330, tag scan support module 370, web page analyzer support module 340, and credit card support module 380 can also be provided in processing module 210. Parse support module 330 can provide features for analyzing the syntax of the URL associated with a given web page. Specifically, the parse support module 330 can break down the URL into its major component parts: scheme (defines the way the page should be interpreted, such as “http”, “https”, “mailto”, and “ftp”; user (defines a user name and password inline with the URL); domain (identifies the address of the server where the page is located); path (identifies the file path for the page to be found within a particular server); and query (identifies further parameters associated with the URL). It will be appreciated that by comparing the various parts of the URL to standard URL syntax, the parse support module 330 can detect atypical URLs which can be indicative of possible phishing attacks. If detected, an appropriate phishing condition can be set.

Tag scan support module 370 can provide features for detecting and analyzing the tags of a given web page. For example, anchor tags that define links in the web page can be analyzed to determine the underlying HREF associated with the link as well as the visible text associated with the link that is displayed on the page. As a result, discrepancies between the visible text and the underlying HREF can be detected. In addition, form tags can be detected to determine the existence of a form on the page. Input form tags can also be detected, including the use of the “password” type.

Web page analyzer support module 340 can provide features for analyzing non-tagged content of a given web page. The web page analyzer support module 340 can access a pre-sorted dictionary comprising word phrases (for example, terms associated with financial information and/or credit cards) commonly associated with phishing attacks, and compare the text found in the web page with entries in the dictionary. Module 340 can score the value of each word phrase times the number of instances in which the phrase is matched on the web page. At the end of the scan, the highest scoring phrase can be identified and an appropriate phishing condition can be set. In another embodiment, the module 340 can be implemented to identify text located inside JavaScript data tables.

Credit card support module 380 can provide features for detecting the existence of credit card numbers entered into a non-secured form (for example, a form on a page using an HTTP instead of a HTTPS scheme). Keystrokes entered by the user through input 190 can be received and analyzed for the unique starting patterns associated with various credit card providers. After one of the starting patterns is detected and a sufficient number of digits is received (for example, 16 digits), module 380 can perform a checksum on the digits to determine whether a credit card number has actually been entered. If the checksum is valid, then an appropriate phishing condition can be set. Advantageously, the actual credit card number is never stored in non-volatile memory and is never transmitted outside of software 160.

The interaction between processing module 210 and browser 140, email client 150, and user input 190 will now be described primarily in the context of browser 140 being implemented as an Internet Explorer application, and email client 150 being implemented as an Outlook or Outlook Express application. However, it will be appreciated that other application-specific software can be provided (for example, application processing module 220) for supporting interaction with one or more other applications 170.

Anti-phishing software 160 can be implemented to communicate with Internet Explorer, America Online, Eudora, Outlook, and Outlook Express through the MSHTML and Active Accessibility interfaces of the Windows operating system. In order to interrogate the processes running under a Windows operating system of computer 130, a global hook can be provided that is called by every running process. When a process connects, its process name is interrogated, and appropriate engines can be created for managing communications associated with processes sought to be monitored by software 160. The specific connection implementations between software 160 and browser 140, email client 150, and/or user input 190 can be encapsulated into engines 310 and 350.

Engine 310 can be implemented to manage connections initiated by browser 140 through the Browser Helper Object (BHO) registry mechanism the Windows operating system. Engine 310 can further be implemented to include a compatible COM (Component) object to interface with browser 140. Entries can be added under the Browser Helper Object (BHO) registry key: “HKEY_LOCAL_MACHINE/Software/Microsoft/Windows/CurrentVersion/Explorer/Browser Helper Objects.” Such entries are UUID references to registered COM (Component) objects found in the class ID registry key: “HKEY_CLASSES_ROOT/CLSID.” Internet Explorer looks through the BHO entry list and attaches to each registered component through the SetSite method. Internet Explorer then “connects” to the valid component through the Connect method. A hook can be attached to the running instance of MSHTML owned by Internet Explorer.

Engine 350 can be implemented to further manage communication between browser 140 and/or email client 150 and the processing module 210. When interfacing with Internet Explorer, engine 350 can be implemented to look for the “Internet Explorer_Server” class, a signature of an active MSHTML session owned by a target application. Once found, the window handle can be mapped through the Active Accessibility object to locate an active MSHTML session.

In order to manage an email client 150, the name of the email client process can be matched to a list of process names that use engine 350. In various embodiments, this process matching step can filter the fully qualified path to the application to reveal a particular product name, such as: “WAOL.EXE” for an America Online client, “OUTLOOK.EXE” for a Microsoft Outlook mail client, “MSIMN.EXE” for a Microsoft Outlook Express mail client, and “EUDORA.EXE” for an Eudora mail client.

If a match is found, the appropriate accessibility interface engine 350 associated with the process can be started to manage communications received from the process. The engine 350 can establish a message hook 320 and keyboard hook 360 for the process, and the message hook 320 can wait until it finds the “Internet Explorer_Server” window class, indicating a window managed by MSHTML. The window handle can be mapped to an “IHTMLDocument” pointer (a MSHTML class) using Active Accessibility of a Windows operating system.

After a web page is fully loaded, the web page's URL can be reviewed to determine if it has been previously processed. The URL scheme can then be reviewed. In various embodiments, the following URL schemes can be employed for matching the document to a particular mail client: “MIP://” for an America Online client, “OUTBIND://” for a Microsoft Outlook mail client, “MID://” for a Microsoft Outlook Express mail client, and “FILE://” for an Eudora mail client. If the scheme corresponds to a mail client scheme, then the web page is detected and can be subsequently processed by the various appropriate components of software 210.

In order to manage a browser 140, the name of the browser process can be matched to a list of process names that use engine 350. Similar to the management of email clients, if a match is found, the appropriate accessibility interface engine 350 associated with the process can be started to manage communications received from the process. The engine 350 can establish a message hook 320 and keyboard hook 360 for the process, and the message hook 320 can wait until it finds the “Internet Explorer_Server” window class. The window handle can be mapped to an “IHTMLDocument” pointer (a MSHTML class) using Active Accessibility.

A parent “IHTMLWindow2” object can be located for controlling the “IHTMLDocument2” object. A “IserviceProvider” object can also be located for controlling the “IHTMLWindow2” object. As a result, the “IserviceProvider” object provides identification of a “IwebBrowser” object, allowing the connection of a web browser hook. As a result, a web page can be detected and can be subsequently processed by the various appropriate components of software 210.

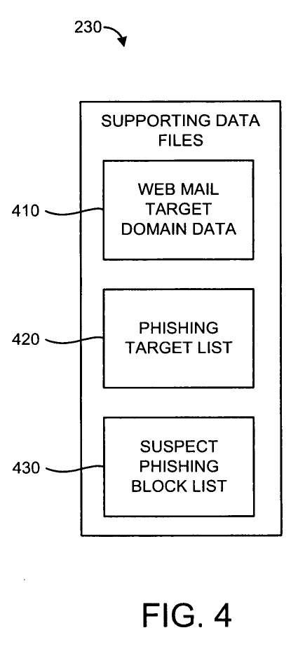

FIG. 4 illustrates a block diagram of supporting data files 230 in accordance with an embodiment of the present invention. In various embodiments, data files 230 can comprise information that can be accessed and processed by processing modules 210 and/or 220 to determine the existence of one or more phishing conditions. The data files 230 can be periodically updated to include further information through daily updates or other appropriate methods.

Web mail target domain data file 410 can provide a set of identifying properties that are associated with various web mail systems known in the art. Such information can be reviewed by processing modules 210 and/or 220 for web pages that are accessed by browser 140 and contain email content (i.e. web mail pages).

Specifically, the data file 410 can include the following information associated with particular web mail providers: a host name to be matched in the domain name portion of the URL address of the web mail provider (for example “mail.yahoo.com”); a query term that is used in a query portion of the URL address of the web mail provider (for example, “msgid”); a secondary query providing a list of parameters in the string value of a primary query term associated with the web mail provider; and a secondary query delimiter that is different than the “&” character that is often used as a primary query delimiter. For web mail systems that purposefully redirect hyperlinks through their system for further processing, an additional re-anchor query term can also be specified for identifying how to find an underlying URL address to be parsed.

It will be appreciated that the various identifying properties can vary depending on the particular type of web mail system used. For Yahoo Mail (hostname “mail.yahoo.com”), the query term is “msgid”. On email “mailto:” hyperlinks, Yahoo Mail redirects the reference to its “compose email” page. for Google Gmail (hostname “gmail.google.com”), the query term is “th”. For AOL Webmail (hostname “webmail.aol.com”), the query term is “folder”. For Hotmail (hostname “hotmail.msn.com”), the query term is “msg”. In addition, the underlying URL for hyperlinks accessed in Hotmail email messages are redirected through Hotmail and can be found using the re-anchor query term “hm_action”. For FastMail (hostname “fastmail.fm”), the query term is “msr” and the secondary query term is “smr-msgid” found in a substring delimited by the “;” character.

Other information associated with some of these and other web mail providers are set forth in the following table 1:

TABLE 1

| | | Secondary | Secondary | |
|---|---|---|---|---|
| Web Mail | | Query | Query | Re- |
| Provider | Query Term | Term | Delimiter | Anchor |
| Hotmail.msn.com | Msg | | | |
| mail.yahoo.com | Msgid | | | |
| gmail.google.com | Th | | | |
| Webmail.aol.com | Folder | | | |
| email.excite.com | mid | | | |
| mail.lycos.com | msg_uid | | | |
| mail.com | msg_uid | | | |
| Fastmail.fm | Mls | smr-msgid | ; | |
| email.myway.com | mid | | | |
| cox.net | Msgvw | | | |
| mail2webm.com | Mb | | | |

It will be appreciated that information associated with additional web mail clients can be added to data file 410 where appropriate.

Phishing target list 420 can provide a list of URLs that have been found to be likely used in connection with a phishing attack. For example, in one embodiment, the following URLs can be included in the list 420: “bankofamerica.com”, “boa.com”, “wellsfargo.com”, “washingtonmutual.com”, “wamu.com”, “firstusa.com”, and “citibank.com”. The URL HREF links found in email messages can be compared against these and/or other URLs and processed as further described herein.

Suspect phishing block list 430 further provide a range of IP blocks that identify groups of IP addresses from which phishing attacks have frequently originated. The list can be implemented to provide a starting IP block, ending IP block, and a country code which can be utilized for identification. The following table 2 provides an example of information that can be provided in list 430 expressed in 32-bit format:

TABLE 2

1040547840|1040580607|643|
1041252864|1041253119|643|
1041253376|1041268735|643|
1042350080|1042415615|643|
1044185088|1044193279|643|
1044381696|1044389887|643|
1044709376|1044717567|643|
1045168128|1045233663|643|
1045716992|1045725183|643|
1046069248|1046085631|643|
1046904832|1046937599|643|
1047076864|1047085055|643|
1047101440|1047109631|643|

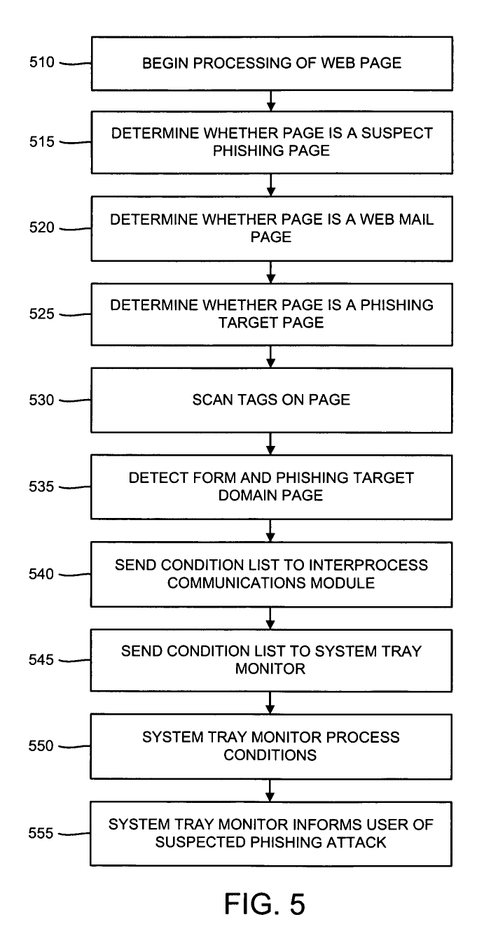

Turning now to various methods supported by system 100, FIG. 5 is a flowchart illustrating a process for detecting phishing attacks in accordance with an embodiment of the present invention.

At step 510, processing module 210 begins the processing of a web page to determine the existence of one or more phishing conditions. It will be appreciated that step 510 can be performed in response to the detection of a web page by engine 310 and/or 350 of software 210. In steps 515 through 535, software 210 performs steps to determine the existence of several conditions that can be indicative of a phishing attack in connection with the web page. As illustrated, these steps can include: determining whether the page is a suspect phishing page (step 515), determining whether the page is a web mail page (step 520), determining whether the page is a phishing target page (step 525), scanning tags of the page (step 530), and detecting a form and a phishing target domain page (step 535). Each of steps 515 through 535 can be performed in accordance with the various processes further described herein in relation to FIGS. 5 through 10.

A list of the conditions detected in steps 515 through 535 and/or detected in accordance with other features described herein can be sent from processing module 210 to communications module 240 (step 540), which then sends the conditions to the system tray monitor 250 (step 545). At step 550, system tray monitor 250 processes the conditions received from module 240. Based on the processing of step 550, the monitor 250 can inform the user of a suspected phishing attack (step 555).

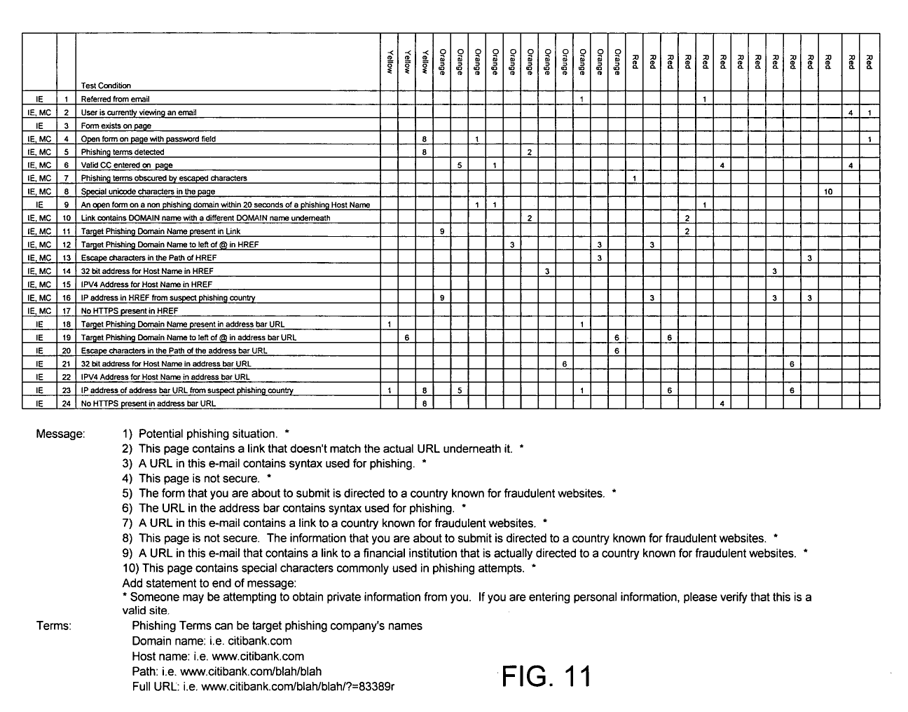

In various embodiments, the processing step of 550 can include comparing the conditions received in step 545 with a set of conditions associated with various possible phishing attacks, and assigning an alert level based on the set of conditions. For example, FIG. 11 illustrates a heuristics table identifying a possible matrix of various phishing conditions and the alert levels that can be assigned in response thereto, as well as messages that can be displayed to the user in connection with an alert window and/or icon. It will be appreciated that higher level alerts can be given priority over lower level alerts.

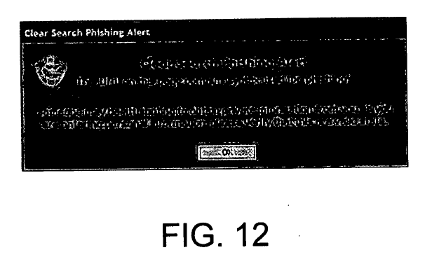

After an alert level is assigned in step 550, the system tray monitor can inform the user of the suspected phishing attack (step 555). As discussed, in various embodiments, this can be achieved through the display of an alert window, an icon in the system tray portion of a Windows-based user interface, and/or other information in the display 180 of system 100. FIG. 12 illustrates an alert window that can be displayed to the user in at least one such embodiment.

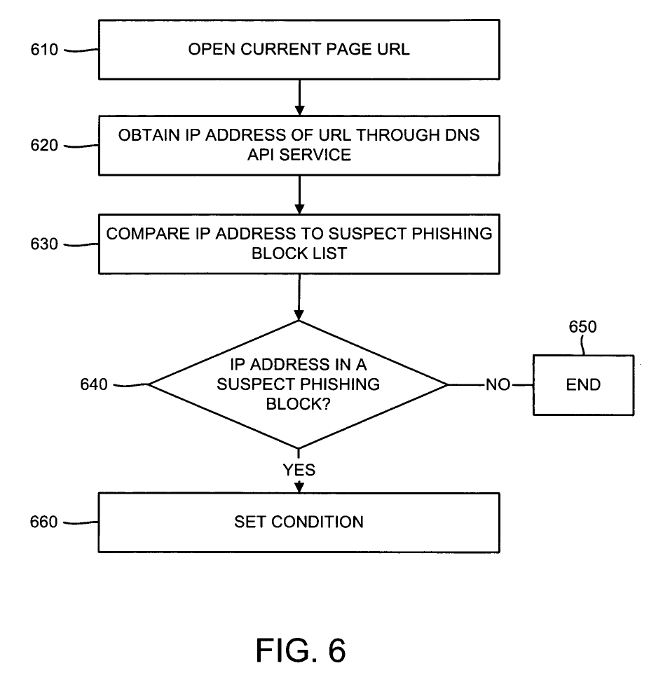

FIG. 6 is a flowchart illustrating a process for detecting a suspect phishing page in accordance with an embodiment of the present invention. As discussed, the process of FIG. 6 can be performed during step 515 of the process of FIG. 5.

At step 610, the URL of the web page is opened and an IP address of the URL is subsequently obtained through the appropriate DNS API service (step 620). The IP address obtained in step 620 can then be compared with the suspect phishing block list 430 to determine whether the IP address falls within any range of addresses referenced by the list 430 (step 630). If a match is found (step 640), then an appropriate phishing condition is set and provided to the interprocess communication module 240 (step 660). Otherwise, the process of FIG. 6 ends (step 650).

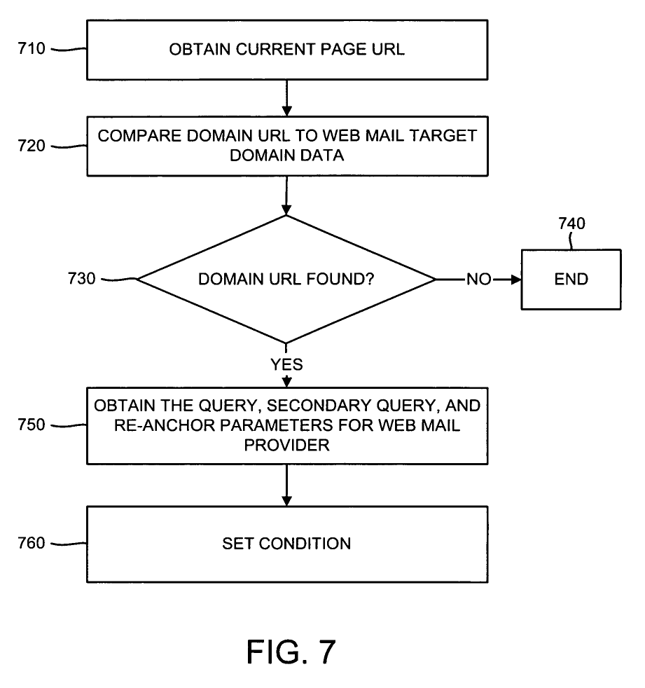

FIG. 7 is a flowchart illustrating a process for detecting a web mail page in accordance with an embodiment of the present invention. As discussed, the process of FIG. 7 can be performed during step 520 of the process of FIG. 5.

At step 710, the URL of the web page is opened and the domain of the URL is compared with the web mail target domain data 410 (step 720). If a match is found (step 730), then the query, secondary query, and re-anchor parameters for the matched web mail provider are obtained from the web mail target domain data 410 (step 750), and an appropriate phishing condition is set which is to be provided to the interprocess communication module 240 (step 760). Otherwise, the process of FIG. 7 ends (step 740).

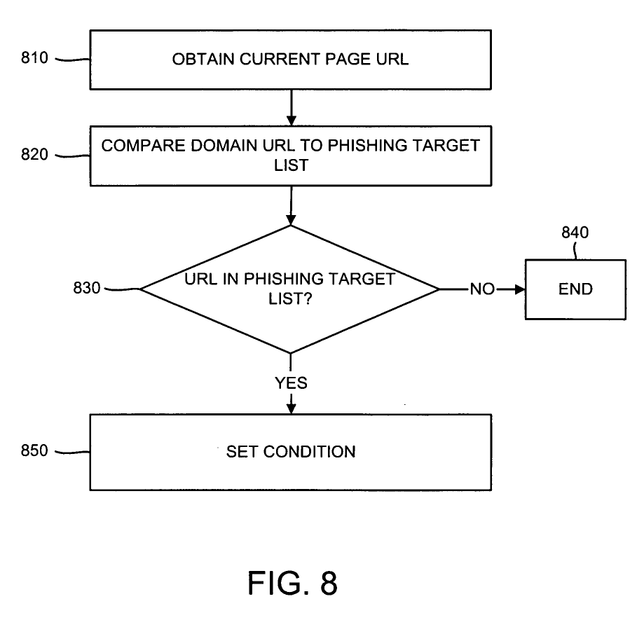

FIG. 8 is a flowchart illustrating a process for detecting a phishing target page in accordance with an embodiment of the present invention. As discussed, the process of FIG. 8 can be performed during step 525 of the process of FIG. 5.

At step 810, the URL of the web page is opened and the domain of the URL is compared with the phishing target list 420 (step 820). If a match is found (step 830), then an appropriate phishing condition is set which is to be provided to the interprocess communication module 240 (step 850). Otherwise, the process of FIG. 8 ends (step 840).

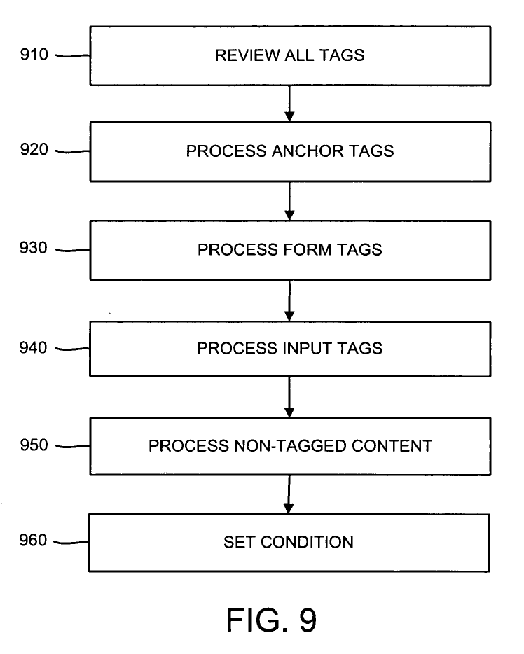

FIG. 9 is a flowchart illustrating a process for scanning HTML tags in accordance with an embodiment of the present invention. As discussed, the process of FIG. 9 can be performed during step 530 of the process of FIG. 5.

At step 910, the tags of a given web page are reviewed. Then, in steps 920, 930, 940, and 950, the anchor tags, form tags, input tags, and non-tagged content can be processed. If any of the processing steps reveal a phishing condition, then an appropriate phishing condition is set which is to be provided to the interprocess communication module 240 (step 960).

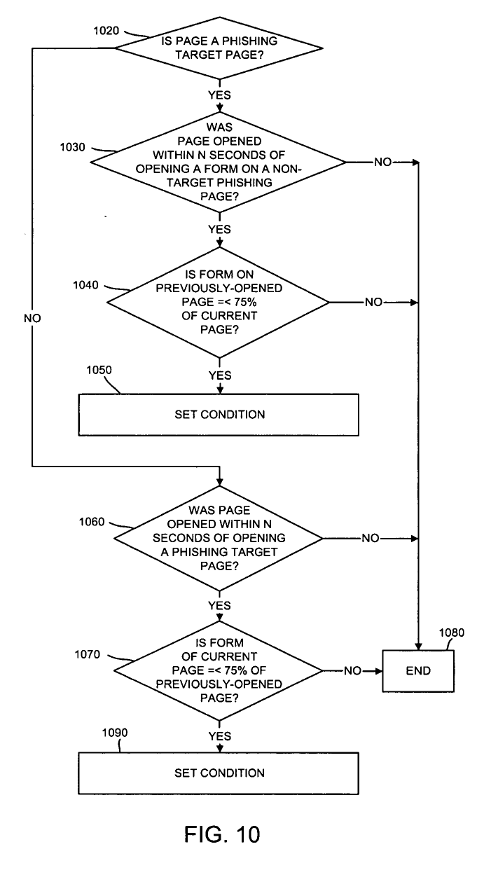

FIG. 10 is a flowchart illustrating a process for detecting a form and a phishing target domain page in accordance with an embodiment of the present invention. As discussed, the process of FIG. 10 can be performed during step 535 of the process of FIG. 5.

At step 1020, a determination is made as to whether the page is a phishing target page. It will be appreciated that the inquiry of step 1020 can be determined by considering whether a condition was set in step 850 of FIG. 8. If a phishing target page was detected, then the process continues to step 1030. Otherwise, the process continues to step 1060.

At step 1030, a determination is made as to whether the web page was opened within a predetermined period of time (for example, “N” seconds) of the opening of a form on a non-target phishing page. If so, then the process continues to step 1040. At step 1040, a determination is made as to whether the form on the previously-opened page comprises 75% or less of the current page. If the answer is yes, then an appropriate phishing condition is set which is to be provided to the interprocess communication module 240 (step 1050).

At step 1060, a determination is made as to whether the web page was opened within a predetermined period of time (for example, “N” seconds) of the opening of a phishing target page. If so, then the process continues to step 1070. At step 1070, a determination is made as to whether the form on the current page comprises 75% or less of the previously-opened page. If the answer is yes, then an appropriate phishing condition is set which is to be provided to the interprocess communication module 240 (step 1090).

As illustrated, if the conditions specified in any of the inquiries of steps 1030, 1040, 1060, or 1070 are not met, then the process of FIG. 10 ends (step 1080).

In view of the present disclosure, it will be appreciated that many of the various characteristics of phishing attacks described herein can be detected in accordance with the features provided by anti-phishing software 160. Appropriate phishing conditions can be set in response thereto, and can be passed to system tray monitor 250 through interprocess communications module 240 for comparison to sets of conditions associated with various possible phishing attacks, and assigning an alert level based on the set of conditions.

For example, software 160 can detect whether a web page has been referred from an email message by comparing the URL of the page against a list of web pages referenced by interprocess communications module 240. Software 160 can also detect whether phishing terms were found on a web page through the features of web page analyzer support module 340 described above. Software 160 can further detect whether a target phishing domain name is present as a link on a web page through the tag scanning process of FIG. 9.

In addition, software 160 can be configured to detect whether a target phishing domain name appears to the left of an “@” character, the use of escape characters in a URL, the use of 32-bit addresses in a URL, the use of a dotted decimal address in a URL, whether a HTTPS scheme is used, and other atypical URL implementations. It will be appreciated that this can be achieved through the features of URL parse support module 330.

Software 160 can further be configured to detect the use of a hostname with a different hostname underneath by analyzing the anchor tags appearing in a web page or email message.

Software 160 can further be configured to detect the presence of a form on a non-phishing target domain page within a period of time of the opening of a phishing target domain page through the tag scanning process of FIG. 10.

Software 160 can further be configured to detect the presence of a form on a non-phishing target domain page within a period of time of the opening of a phishing target domain page through the tag scanning process of FIG. 10.

Software 160 can further be configured to detect the entry of a credit card through the features of credit card support module 380.

Software 160 can further be configured to detect the presence of an open form with a password field on a web page through the features of tag scan support module 370.

Software 160 can further be configured to detect the IP address of a suspected phishing country through the process of FIG. 6.

Where applicable, the present invention can be implemented using hardware, software, or combinations of hardware and software. Also where applicable, the various hardware components and/or software components set forth herein can be combined into composite components comprising software, hardware, and/or both without departing from the spirit of the present invention. Where applicable, the various hardware components and/or software components set forth herein can be dissected into sub-components comprising software, hardware, or both without departing from the spirit of the present invention. In addition, where applicable, it is contemplated that software components can be implemented as hardware components, and vice-versa.

Software in accordance with the present invention, such as program code and/or data, can be stored on one or more computer readable mediums. It is also contemplated that software identified herein can be implemented using one or more general purpose or specific purpose computers and/or computer systems, networked and/or otherwise.

Where applicable, the ordering of various steps described herein can be changed, combined into composite steps, and/or dissected into sub-steps to provide the features described herein.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure.

What is claimed is:

1. A machine-implemented method for detecting a phishing attack over a computer network, the method comprising:
accessing a web page;
processing information associated with the web page;
setting a first condition in response to the processing step;
comparing the first condition to a set of conditions indicative of a phishing attack; and
informing a user of the phishing attack corresponding to the first condition.

2. The method of claim 1, the accessing step is performed in response to the user's selection of a link appearing in an email message.

3. The method of claim 1, the informing step further comprising:
displaying an alert window to the user.

4. The method of claim 1, the informing step further comprising:
displaying an icon to the user.

5. The method of claim 1, the processing step is a step selected from the group consisting of:
parsing a URL associated with the web page;
scanning tags of the web page;
analyzing non-tagged content of the web page;
analyzing input by the user into a form on the web page;
analyzing a URL associated with the web page; and
analyzing an IP address associated with the web page.

6. The method of claim 1, the first condition is a condition selected from the group consisting of:
detection of the web page being opened by the user in response to a hyperlink appearing in an email message;
detection of the user currently viewing an email message;
detection of a form existing on the web page;
detection of an open form having a password field existing on the web page;
detection of phishing terms appearing on the web page;
detection of a valid credit card number entered by the user;
detection of escape characters used to obscure phishing terms;
detection of UTF-8 representation of regular printing ASCII characters on the web page;
detection of an open form on a non phishing domain that has been opened within a period of time of the opening of a second web page having a target phishing host name;
detection of a link comprising a visible domain name that differs from a domain name of a URL associated with the link;
detection of a link comprising a target phishing domain name;
detection of a link comprising a target phishing domain name to the left of a @ character in a HREF associated with the link;
detection of escape characters in a path of a HREF;
detection of a 32-bit address used for a host name in a HREF;
detection of a IPV4 address used for a host name in a HREF;
detection of an IP address from a suspect phishing country in a HREF;
detection of a non-HTTPS scheme in a HREF;
detection of a target phishing domain name in a URL;
detection of a target phishing domain name to the left of a @ character in a URL;
detection of escape characters in the path of a URL;
detection of a 32-bit address used for a host name in a URL;
detection of a IPV4 address used for a host name in a URL;
detection of an IP address from a suspect phishing country in a URL; and
detection of a non-HTTPS scheme in a URL.

7. The method of claim 1, method comprising:
setting a second condition in response to the processing step;
in place of the first comparing step, comparing the first and second conditions to a set of conditions indicative of a phishing attack; and
in place of the first informing step, informing a user of the phishing attack corresponding to the first and second conditions.

8. A system for detecting a phishing attack over a computer network in communication with the system, the system comprising a computer for performing a method comprising the steps:
accessing a web page;
processing information associated with the web page;
setting a first condition in response to the processing step;
comparing the first condition to a set of conditions indicative of a phishing attack; and
informing a user of the phishing attack corresponding to the first condition.

9. The system of claim 8, the accessing step is performed in response to the user's selection of a link appearing in an email message.

10. The system of claim 8, the informing step further comprising:
displaying an alert window to the user.

11. The system of claim 8, the informing step further comprising:
displaying an icon to the user.

12. The system of claim 8, the processing step is a step selected from the group consisting of:
parsing a URL associated with the web page;
scanning tags of the web page;
analyzing non-tagged content of the web page;
analyzing input by the user into a form on the web page;
analyzing a URL associated with the web page; and
analyzing an IP address associated with the web page.

13. The system of claim 8, the first condition is a condition selected from the group consisting of:
detection of the web page being opened by the user in response to a hyperlink appearing in an email message;
detection of the user currently viewing an email message;
detection of a form existing on the web page;
detection of an open form having a password field existing on the web page;
detection of phishing terms appearing on the web page;
detection of a valid credit card number entered by the user;
detection of escape characters used to obscure phishing terms;
detection of UTF-8 representation of regular printing ASCII characters on the web page;
detection of an open form on a non phishing domain that has been opened within a period of time of the opening of a second web page having a target phishing host name;
detection of a link comprising a visible domain name that differs from a domain name of a URL associated with the link;
detection of a link comprising a target phishing domain name;
detection of a link comprising a target phishing domain name to the left of a @ character in a HREF associated with the link;
detection of escape characters in a path of a HREF;
detection of a 32-bit address used for a host name in a HREF;
detection of a IPV4 address used for a host name in a HREF;
detection of an IP address from a suspect phishing country in a HREF;
detection of a non-HTTPS scheme in a HREF;
detection of a target phishing domain name in a URL;
detection of a target phishing domain name to the left of a @ character in a URL;
detection of escape characters in the path of a URL;
detection of a 32-bit address used for a host name in a URL;
detection of a IPV4 address used for a host name in a URL;
detection of an IP address from a suspect phishing country in a URL; and
detection of a non-HTTPS scheme in a URL.

14. The system of claim 8, method comprising:
setting a second condition in response to the processing step;
in place of the first comparing step, comparing the first and second conditions to a set of conditions indicative of a phishing attack; and
in place of the first informing step, informing a user of the phishing attack corresponding to the first and second conditions.

15. A computer readable medium with software embodied therein, the software operable to perform a method for detecting a phishing attack over a computer network when run by a computer, the method comprising the steps:
accessing a web page;
processing information associated with the web page;
setting a first condition in response to the processing step;
comparing the first condition to a set of conditions indicative of a phishing attack; and
informing a user of the phishing attack corresponding to the first condition.

16. The computer readable medium of claim 15, the accessing step is performed in response to the user's selection of a link appearing in an email message.

17. The computer readable medium of claim 15, the informing step further comprising:
displaying an alert window to the user.

18. The computer readable medium of claim 15, the informing step further comprising:
displaying an icon to the user.

19. The computer readable medium of claim 15, the processing step is a step selected from the group consisting of:
parsing a URL associated with the web page;
scanning tags of the web page;
analyzing non-tagged content of the web page;
analyzing input by the user into a form on the web page;
analyzing a URL associated with the web page; and
analyzing an IP address associated with the web page.

20. The computer readable medium of claim 15, the first condition is a condition selected from the group consisting of:
detection of the web page being opened by the user in response to a hyperlink appearing in an email message;
detection of the user currently viewing an email message;
detection of a form existing on the web page;
detection of an open form having a password field existing on the web page;
detection of phishing terms appearing on the web page;
detection of a valid credit card number entered by the user;
detection of escape characters used to obscure phishing terms;
detection of UTF-8 representation of regular printing ASCII characters on the web page;
detection of an open form on a non phishing domain that has been opened within a period of time of the opening of a second web page having a target phishing host name;
detection of a link comprising a visible domain name that differs from a domain name of a URL associated with the link;
detection of a link comprising a target phishing domain name;
detection of a link comprising a target phishing domain name to the left of a @ character in a HREF associated with the link;
detection of escape characters in a path of a HREF;
detection of a 32-bit address used for a host name in a HREF;
detection of a IPV4 address used for a host name in a HREF;
detection of an IP address from a suspect phishing country in a HREF;
detection of a non-HTTPS scheme in a HREF;
detection of a target phishing domain name in a URL;
detection of a target phishing domain name to the left of a @ character in a URL;
detection of escape characters in the path of a URL;
detection of a 32-bit address used for a host name in a URL;
detection of a IPV4 address used for a host name in a URL;
detection of an IP address from a suspect phishing country in a URL; and
detection of a non-HTTPS scheme in a URL.

21. The computer readable medium of claim 15, method comprising:
setting a second condition in response to the processing step;
in place of the first comparing step, comparing the first and second conditions to a set of conditions indicative of a phishing attack; and
in place of the first informing step, informing a user of the phishing attack corresponding to the first and second conditions.
